(19) United States
(12) Patent Application Publication
(10) Pub. No.: US 2026/0067008 A1
(43) Pub. Date: Mar. 5, 2026

(54) ABSOLUTE ACCURATE ON-CHIP RF SOURCE FOR BUILT-IN SELF-TEST

(71) Applicant: Qorvo US, Inc., Greensboro, NC (US)

(72) Inventor: Jeroen Cornelis Kuenen, Beuningen (NL)

(21) Appl. No.: 19/297,714

(22) Filed: Aug. 12, 2025

Related U.S. Application Data
(60) Provisional application No. 63/690,948, filed on Sep. 5, 2024.
(60) Provisional application No. 63/722,101, filed on Nov. 19, 2024.

(51) Int. Cl. H04B 17/29; H04B 1/16; H04B 17/21

(52) U.S. Cl. CPC H04B 17/29; H04B 1/16; H04B 17/22

(57) ABSTRACT

The present disclosure provides a radio frequency (RF) receiver front-end comprising an RF integrated circuit chip with an antenna port terminal for coupling to an external antenna. The chip includes a low-noise amplifier coupled between an RF input terminal and an RF output terminal; an integrated built-in self-test system featuring resistors, a test switch, an oscillator generating a square-wave signal for testing, a buffer sharpening edges of the square-wave signal, and a controller performing self-tests to determine one or more characteristics of the RF receiver front-end. Additionally, an analog-to-digital converter converts test signals into digital form for analysis by the controller. An electronically controllable antenna switch is included to facilitate selective coupling between the antenna port and the RF input terminal during reception of RF signals or built-in self-testing. The system enables efficient testing and characterization of the RF receiver front-end directly on-chip, enhancing reliability in wireless communications devices.

### RELATED APPLICATIONS

This application claims the benefit of provisional patent application Ser. No. 63/722,101, filed Nov. 19, 2024, and claims the benefit of provisional patent application Ser. No. 63/690,948, filed Sep. 5, 2024, the disclosures of which are hereby incorporated herein by reference in their entireties.

### FIELD OF THE DISCLOSURE

The present disclosure relates generally to radio frequency chip testing and, more particularly, to an on-chip radio frequency source for generating calibration signals during production test and in the field.

### BACKGROUND

Radio frequency (RF) chips are essential components in various wireless communication systems. Testing these chips is crucial to ensure their proper functionality and performance. Traditionally, RF chip testing is performed using external RF testers with dedicated signal sources. However, these external RF testers can be prohibitively expensive, especially when accounting for the high cost per second test time. What is needed is an absolute accurate on-chip RF source for built-in self-test so that reliance on an external RF tester may be eliminated.

Testing of RF chips is currently performed with RF production testers. These have a signal source suited to supply RF signals to the device under test. The price of these testers is significantly higher per second test time than non-RF testers.

The RF interfacing from load board to the chip is critical: the impedance seen by the chip must be precise (often 50 ohms) to guarantee accuracy of the level arriving on the chip. A complicating factor is that the contact resistance between probe and landing pad on the die changes over the number of touch downs.

Changing the power level of frequency of the RF source in the tester is slow, in the order of milliseconds, while the RF source on chip according to the present disclosure is adjustable within microseconds. This reduces test time.

### SUMMARY

The present disclosure pertains to a radio frequency (RF) receiver front-end that includes an RF integrated circuit chip with an antenna port terminal for coupling to an external antenna. The chip comprises a low-noise amplifier disposed within the chip, which is coupled between an RF input terminal and an RF output terminal, with the RF input terminal connected to the antenna port terminal.

The disclosure also features an RF calibration generator with a built-in self-test system integrated onto the RF integrated circuit chip. This system includes a first resistor series-coupled between the RF input terminal and a fixed voltage node (ground or reference voltage) through a test node. Additionally, an electronically controllable test switch is coupled in series with the first resistor between the RF input terminal and the fixed voltage node. An oscillator within the system generates a square-wave signal for a test signal, while a buffer such as a logic gate, having an input coupled to the output of the oscillator, sharpens edges of the square-wave signal using rail-to-rail amplitude. A second resistor is coupled between the output of the logic gate and the test node.

The RF receiver front-end further comprises a controller configured to perform a built-in self-test to determine one or more characteristics of the RF receiver front-end. The system may also include an analog-to-digital converter having an analog input selectively coupled to an RF output node or alternatively selectively coupled to an external test terminal that may be coupled to external RF circuitry to be tested via the built-in self-test. The analog-to-digital converter further includes a digital output, wherein the controller is configured to close the electronically controllable test switch to perform the built-in self-test, receive a digitized version of a test signal at the RF output node or the external test terminal, and open the electronically controllable test switch during reception of RF signals through the antenna port. The RF receiver front-end may also include an electronically controllable antenna switch coupled in series between the antenna port and the RF input terminal, wherein the controller is configured to close the electronically controllable antenna switch during reception of RF signals through the antenna port and open the electronically controllable antenna switch during the built-in self-test.

The RF calibration generator integrated onto the RF integrated circuit chip:
Has very accurate absolute power level.
Has no need for an RF interface from production tester load board to device under test.
Has no need for a more expensive production tester with RF source included.
Is faster to setup and modify the RF source, thereby reducing test time.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is a diagram showing an embodiment according to the present disclosure.

FIG. 2 is a diagram showing modification of the power level of the radio frequency source.

FIG. 3 is a schematic diagram of an exemplary communication device wherein the power radio frequency receiver front-end may be employed.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

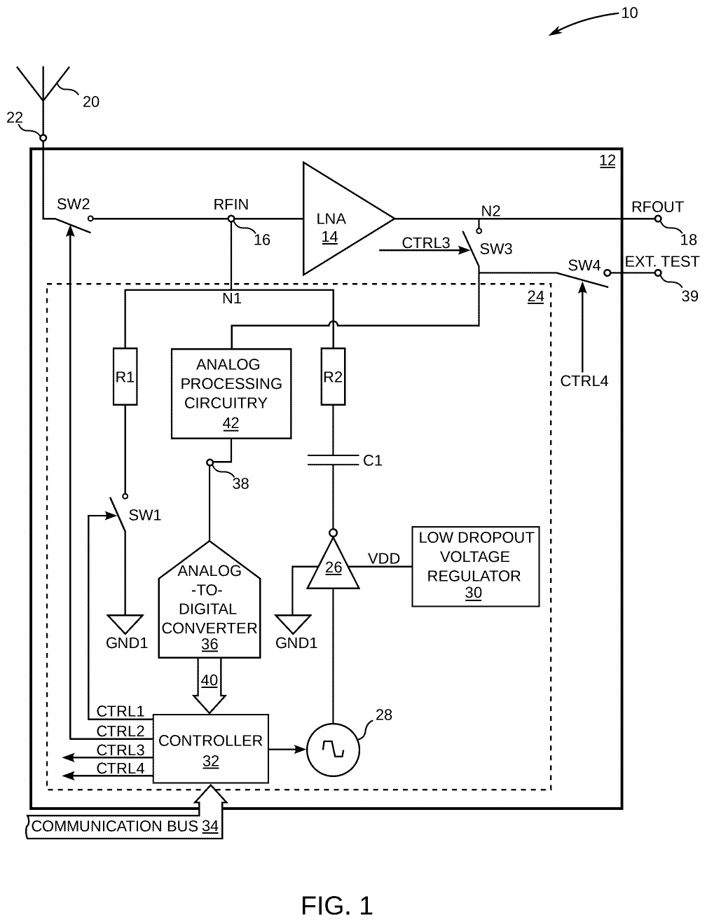

FIG. 1 is a schematic of a first embodiment of the disclosure that provides an absolute accurate on-chip RF source for built-in self-test for a radio frequency (RF) receiver front-end 10. In this first embodiment, the RF receiver front-end 10 has an RF integrated circuit chip 12 that includes a low-noise amplifier (LNA) 14 that is coupled between an RF input terminal 16 and a RF output terminal 18. An antenna 20 couples to the RF input terminal 16 through an antenna port terminal 22.

An RF calibration generator 24 is integrated onto the RF integrated circuit chip 12 and is configured to provide the built-in self-test. The RF calibration generator 24 has a first resistor R1 that is selectively coupled to a fixed voltage node GND1 through an electronically controllable first switch SW1. In this exemplary embodiment the fixed voltage node is ground. The first resistor R1 typically has a resistance of 50 Ω±10%. The first resistor R1 and the first switch SW1 are coupled in series between the RF input terminal 16 and the fixed voltage node GND1 through an input test node N1.

The RF calibration generator 24 also includes a buffer such as a logic gate 26 having an input coupled to the output of an RF oscillator 28 that is configured to generate a relatively large square-wave that is an input test signal for the built-in self-test. The logic gate 26 is configured to sharpen edges of the generated square-wave and to ensure a more defined high state and low state. In the exemplary embodiment of FIG. 1, the logic gate 26 is a NOT gate configured to function as a digital inverter. However, it is to be understood that the buffer is limited to a digital logic gate but may also be realized as an analog buffer. Such an analog buffer has a rail-to-rail output that sharpens the edges of the square wave generated by the RF oscillator 28. The RF oscillator 28 may be of the ring-type oscillator having an odd number of NOT gates connected in a loop (not shown).

A low-dropout voltage regulator 30 generates a supply voltage VDD to supply the logic gate 26. In the exemplary embodiment of FIG. 1, the supply voltage VDD is calibrated between 800 mV and 810 mV.

The logic gate 26 is also configured to output the input test signal with a rail-to-rail amplitude that transitions substantially between 0 V and the supply voltage VDD. Moreover, due to modern integrated circuit processes, the logic gate 26 is configured to switch between low and high substantially faster than the RF frequencies of RF signals that will be received by the RF receiver front-end 10. The logic gate 26 is configured to output the input test signal with substantially shortened rise and fall times. For example, the exemplary embodiment of FIG. 1 is configured to receive RF signals within a band having a center frequency of around 2.4 GHZ, and modern complementary metal oxide semiconductor logic for RF applications employing logic gate 26 provides operation at RF frequencies substantially above 2.4 GHz. For example, in some embodiments the logic gate 26 is configured for operation between 25 GHz and 50 GHz. In other embodiments the logic gate 26 is configured for operation between 50 GHz and 100 GHz. Moreover, in some applications in yet other embodiments, the logic gate 26 is configured for operation above 100 GHz.

The input test signal is passed to the RF input terminal 16 through a first coupling capacitor C1 and a second resistor R2, wherein the first coupling capacitor and the second resistor R2 are coupled in series between an output of the logic gate 26 and the input test node N1 that is coupled to the RF input terminal 16.

In the exemplary embodiment of FIG. 1, the RF calibration generator 24 further includes a controller 32 that has a communication bus 34 that is bi-directional and is configured to pass data and controller commands between an external processor (not shown). In the exemplary embodiment of FIG. 1, the controller 32 is configured to selectably drive the first switch SW1 open and close by generating a first control signal CTRL1. The first switch SW1 is typically driven closed by the controller 32 during a built-in self-test and driven open by the controller 32 during normal operation when the RF receiver front-end 10 is receiving an RF signal arriving from the antenna 20. The controller 32 is also configured to selectively drive open and close a second switch SW2 by generating a second control signal CTRL2. The second switch SW2 is coupled between the antenna port terminal 22 and the RF input terminal 16. The controller 32 driving the second switch SW2 open leaves the antenna port terminal 22 floating during a built-in self-test.

An analog-to-digital converter 36 has an analog input 38 coupled to an output test node N2 through a third switch SW3 or to an external test terminal 39 through a fourth switch SW4 and a digital output 40 coupled to the controller 32. The controller 32 is configured to generate a third control signal CTRL3 to selectively open and close the third switch SW3 and generate a fourth control signal CTRL4 to selectively open and close the fourth switch SW4. The controller 32 is configured to selectively receive a digitized version of an output test signal at the output test node N2 or at the external test terminal 39. To select the output test signal at the second test node, the controller 32 generates the fourth control signal CTRL4 to open the fourth switch SW4 and then generates the third control signal CTRL3 to close the third switch SW3. To select the output test signal at the external test terminal 39, the controller 32 generates the third control signal CTRL3 to open the third switch SW3 and generates the fourth control signal CTRL4 to close the fourth switch SW4.

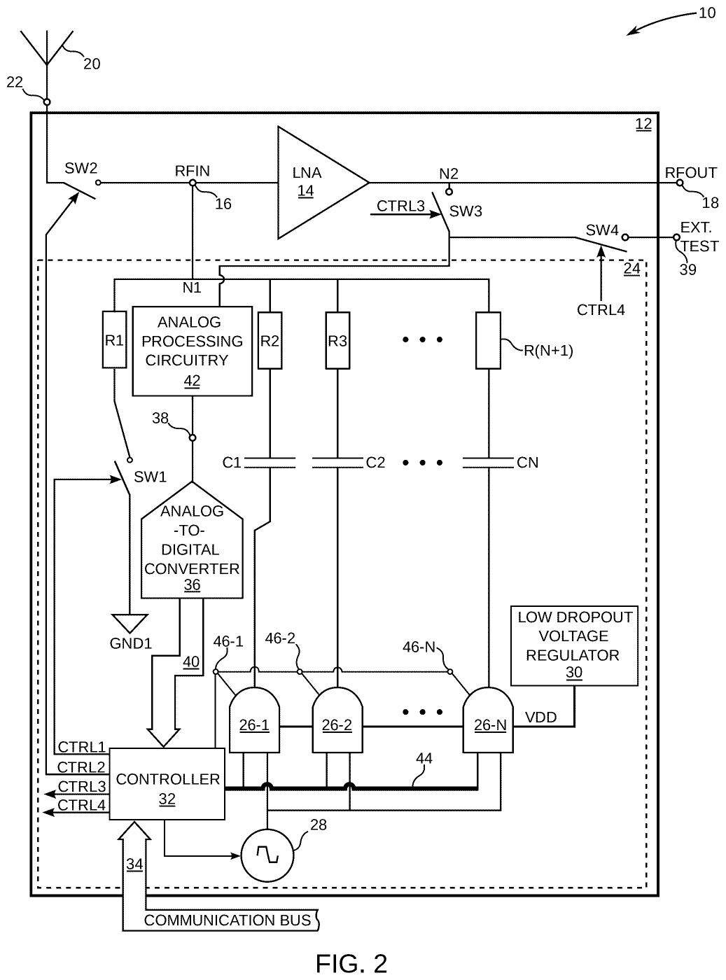

Analog processing circuitry 42 may be employed to prepare the output test signal for accurate conversion by the analog-to-digital converter 36. Before digitization of the output test signal, various analog processing stages may be required to condition the output test signal. Filtering may be employed to isolate the desired frequency bands and remove unwanted noise or interference. Impedance matching networks may make up the analog processing circuitry 42 to ensure substantial power transfer between components. In applications requiring in-phase/quadrature-phase (I/Q) demodulation for digital processing, quadrature demodulators are employed. Phase shifters may be employed for precise timing or phase alignment requirements. The analog processing circuitry 42 may be configured to provide any or all the above-mentioned processing, but the analog processing circuitry 42 is not limited to these processes. For example, as depicted in FIG. 2, the analog processing circuitry 42 is coupled between the output test node N2 and the analog input 38. The analog processing circuitry 42 typically includes a combination of components configured to condition the test signal applied at the output test node N2 for accurate digital sampling and to isolate the analog-to-digital converter 36 from the output test node N2 or external circuitry. The analog processing circuitry 42 may include but is not limited to filters such as low-pass, band-pass, and anti-aliasing filters or combinations thereof to suppress out-of-band noise and prevent aliasing. Other circuitry and components include but are not limited to attenuators and variable gain amplifiers (VGAs) to adjust signal amplitude within the dynamic range of the analog-to-digital converter 36, and impedance-matching networks to ensure maximum power transfer and signal integrity. In some systems, mixers may also be included to downconvert the test signal to an intermediate frequency (IF) or baseband before digitization. This processing chain ensures that the signal presented to the analog-to-digital converter 36 is spectrally clean, amplitude-appropriate, and within the input bandwidth of the analog-to-digital converter 36.

The controller 32 is configured to execute firmware and/or software that controls a built-in self-test for the RF receiver front-end 10. The firmware and/or software that controls the built-in self-test makes the RF calibration generator 24 employable to measure the following nonlimited aspects of the RF receiver front-end 10:
Gain
Gain steps
I/Q imbalance.
Frequency characteristic
Received signal distortion

These measurements may be carried out during production tests and/or subsequently in the field.

During production testing, no connection is made to the device under test (i.e., the RF receiver front-end 10) at the antenna port terminal 22 by leaving the antenna port terminal 22 floating by opening the second switch SW2 by way of the controller 32. This allows the source impedance of the LNA 14 with the first resistor R1 to be determined by closing the first switch SW1. The voltage swing at the LNA output is now determined by the voltage swing of the input test signal at the inverter output, times the attenuation of the first resistor R1 and of the second resistor R2. The attenuation of the input test signal results in changes in the output test signal, which is processed by the analog processing circuitry 42 and then is converted to digital test signal values by the analog-to-digital converter 36. The digital test signal values can then be further processed by the controller 32 to determine results of the built-in self-test and/or the controller 32 may pass the digital test signal values and/or results to an external processor (not shown) for further processing and recording. An accurate attenuation is achieved by matching the resistance of both the first resistor R1 and the second resistor R2.

The main remaining inaccuracy is the source impedance. When the resistors on the device under test are in a process corner, resistance can be 15% lower or higher than typical. When resistors are 15% lower, the largest error occurs, amounting to 0.73 dB.

Accounting for all errors, power level remains with ±1 dB, which is better than the ±2 dB obtained with an external production tester as a source.

To modify the power level of the RF source, the embodiment disclosed in the schematic of FIG. 2 may be deployed. A plurality of logic gates 26-1, 26-2, and 26-N are coupled in parallel between the RF oscillator 28 and the input test node N1. In the exemplary embodiment of FIG. 2, an output of logic gate 26-1 is coupled to the input test node N1 through the first coupling capacitor C1 and the second resistor R2 that are coupled in series. An output of the logic gate 26-2 is coupled to the input test node N1 through a second capacitor C2 and third resistor R3 that are coupled in series. An output of the logic gate 26-N is coupled to the input test node N1 through an Nth capacitor CN and an N+1 resistor R(N+1) that are coupled in series, wherein N is a counting number that is at least 3. In the exemplary embodiment of FIG. 2, the logic gates 26-1 through 26-N are logic AND gates that each have two inputs, an oscillator input coupled to an output of the RF oscillator 28 and an enable input coupled to a control bus 44 of the controller 32. The controller 32 is configured to individually enable output of each of the logic gates 26-1 through 26-N by way of control signals over the control bus 44 being selectively sent to individual ones of the enable inputs. For example, during a built-in self-test any number of the logic gates 26-1 through 26-N may be enabled to digitally control attenuation of the input test signal. In exemplary embodiments, the logic gates 26-1 through 26-N are identical, which makes matching the capacitors C1 through CN and resistors R2 through R(N+1) straightforward.

The logic gates 26-1 through 26-N are also configured to output the input test signal with a rail-to-rail amplitude that transitions substantially between 0 V and the supply voltage VDD. Moreover, due to modern integrated circuit processes, the logic gates 26-1 through 26-N are configured to switch between low and high substantially faster than the RF frequencies of RF signals that will be received by the RF receiver front-end 10. The logic gates 26-1 through 26-N are configured to output the input test signal with substantially shortened rise and fall times. In some embodiments the logic gates 26-1 through 26-N are configured for operation between 25 GHz and 50 GHz. In other embodiments the logic gates 26-1 through 26-N are configured for operation between 50 GHz and 100 GHz. Moreover, in some applications in yet other embodiments, the logic gates 26-1 through 26-N are configured for operation above 100 GHz.

To measure the frequency characteristic of the RF receiver front-end 10 to verify filters during production test, the test signal frequency may be adjusted in substantially small steps. In the embodiments of FIG. 1 and FIG. 2, the controller has an oscillator control output coupled to a frequency control input of the RF oscillator 28. Alternatively, other embodiments provide for a fixed frequency for the input test signal and change the reception frequency of the RF receiver front-end 10.

A potential disadvantage is the loading of the attenuator to the input of the LNA increasing the noise figure of the receiver. One can minimize the impact as follows:
Disconnecting the first resistor R1 by the first switch SW1 when the RF calibration generator 24 is not used.
Limiting the maximum power level that can be injected so that the second resistor R2 may be substantially large.
   Maximum injection level is-36 dBm with <0.1 dB impact on noise figure.
   Alternatively, the logic gates 26-1 through 26-N may be tri-stated to make the outputs of the logic gates 26-1 through 26-N float when the RF calibration generator 24 is not in use. For example, tri-state inputs 46-1, 46-2, and 46-N of the logic gates 26-1, 26-2, and 26-N are coupled to a tri-state control output of the controller 32. The firmware and/or software of the built-in self-state is configured to tri-state the logic gates 26-1, 26-2, and 26-N at the end of the built-in self-test.

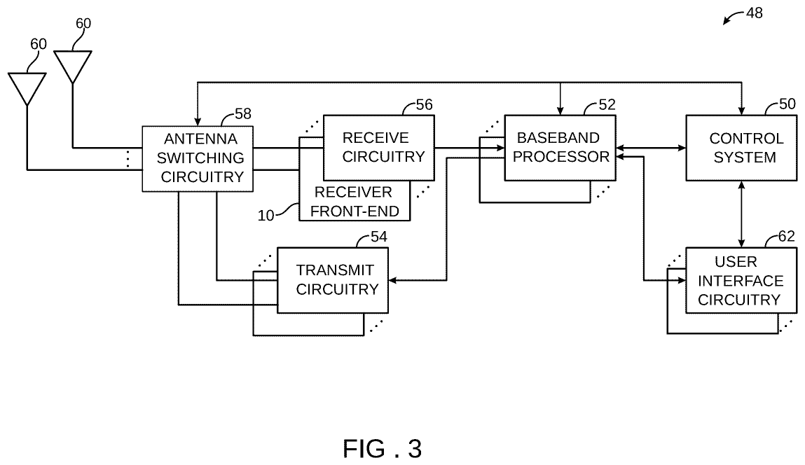

FIG. 3 is a schematic diagram of an exemplary communication device 48 wherein the power RF receiver front-end 10 may be employed. Herein, the communication device 48 can be a communication device such as a mobile terminal, a smart watch, a tablet, a computer, a navigation device, an access point, a basestation (e.g., eNB or gNB), and any other type of wireless communication device that supports wireless communications, such as cellular, wireless local area network (WLAN), Bluetooth, ultra-wideband (UWB), and near-field communications. The communication device 48 generally includes a control system 50, a baseband processor 52, transmit circuitry 54, receive circuitry 56, antenna switching circuitry 58, multiple antennas 60, and user interface circuitry 62. In a non-limiting example, the control system 50 can be a field-programmable gate array (FPGA). In this regard, the control system 50 can include one or more of at least a microprocessor, an embedded memory circuit, and a communication bus interface. The receive circuitry 56 receives radio frequency signals via the multiple antennas 60 and through the antenna switching circuitry 58 from one or more basestations. A low-noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using one or more analog-to-digital converters (ADCs).

The baseband processor 52 processes the digitized received signal to extract the information or data bits conveyed in the received signal. This processing typically comprises demodulation, decoding, and error correction operations, as will be discussed in greater detail below. The baseband processor 52 is generally implemented in one or more digital signal processors (DSPs) and application-specific integrated circuits (ASICs).

For transmission, the baseband processor 52 receives digitized data, which may represent voice, data, or control information, from the control system 50, which it encodes for transmission. The encoded data is output to the transmit circuitry 54, where a digital-to-analog converter (DAC) converts the digitally encoded data into an analog signal and a modulator modulates the analog signal onto a carrier signal that is at a desired transmit frequency or frequencies. A power amplifier amplifies the modulated carrier signal to a level appropriate for transmission and delivers the modulated carrier signal to the multiple antennas 60 through the antenna switching circuitry 58. The multiple antennas 60 and the replicated transmit circuitry 54 and receive circuitry 56 may provide spatial diversity. Modulation and processing details will be understood by those skilled in the art. In an embodiment, the RF receiver front-end 10 may be provided in any one or more of the circuitries in the communication device 48, such as the receive circuitry 56.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A radio frequency (RF) receiver front-end comprising:
an RF integrated circuit chip having an antenna port terminal for coupling to an external antenna;
a low-noise amplifier (LNA) coupled between an RF input terminal and an RF output terminal, wherein the LNA is disposed within the RF integrated circuit chip and the RF input terminal is coupled to the antenna port terminal; and
an RF calibration generator integrated onto the RF integrated circuit chip, configured to provide a built-in self-test for the RF receiver front-end, wherein the RF calibration generator comprises:
a first resistor coupled in series between the RF input terminal and a fixed voltage node through an input test node, wherein the fixed voltage node is defined as ground or a reference voltage;
an electronically controllable test switch coupled in series with the first resistor between the RF input terminal and the fixed voltage node;
an oscillator configured to generate a square-wave signal for a test signal;
a buffer having an input coupled to an output of the oscillator, wherein the buffer is configured to generate the test signal by sharpening edges of the square-wave signal with a rail-to-rail amplitude; and
a second resistor coupled between an output of the buffer and the input test node.

2. The RF receiver front-end of claim 1 further comprising a low-dropout voltage regulator configured to supply a stable supply voltage to the buffer.

3. The RF receiver front-end of claim 2 wherein the supply voltage supplied to the buffer by the low-dropout voltage regulator is between 800 mV and 810 mV.

4. The RF receiver front-end of claim 1 wherein the oscillator is a ring-type oscillator.

5. The RF receiver front-end of claim 1 further comprising a controller configured to perform a built-in self-test to determine one or more characteristics of the RF receiver front-end.

6. The RF receiver front-end of claim 5 further comprising an electronically controllable antenna switch coupled in series between the antenna port terminal and the RF input terminal, wherein the controller is configured to close the electronically controllable antenna switch during reception of RF signals through the antenna port terminal and open the electronically controllable antenna switch during the built-in self-test.

7. The RF receiver front-end of claim 5 further comprising an analog-to-digital converter having an analog input coupled to an output test node associated with the RF output terminal and a digital output, wherein the controller is configured to close the electronically controllable test switch to perform the built-in self-test, receive a digitized version of an output test signal at the output test node, and open the electronically controllable test switch during reception of RF signals through the antenna port.

8. The RF receiver front-end of claim 6 further comprising analog processing circuitry coupled between an input terminal of the analog-to-digital converter and an output test node.

9. The RF receiver front-end of claim 5 wherein the one or more characteristics of the RF receiver front-end are a value of LNA source impedance derived from the output test signal at the output test node.

10. The RF receiver front-end of claim 5 wherein the one or more characteristics of the RF receiver front-end are a value of LNA gain derived from the output test signal at the output test node.

11. The RF receiver front-end of claim 5 wherein the one or more characteristics of the RF receiver front-end are a value of in-phase/quadrature imbalance derived from the output test signal at the output test node.

12. The RF receiver front-end of claim 5 wherein the one or more characteristics of the RF receiver front-end are a frequency characteristic derived from the output test signal at the output test node.

13. The RF receiver front-end of claim 5 wherein the one or more characteristics of the RF receiver front-end are received signal distortion derived from the output test signal at the output test node.

14. The RF receiver front-end of claim 5 wherein the buffer is a first AND gate having an oscillator input coupled to the oscillator and an enable input coupled to a control bus of the controller.

15. The RF receiver front-end of claim 5 further comprising an N number of additional AND gates that each have an oscillator input coupled to the oscillator and an enable input coupled to a control bus of the controller, wherein the N number of additional AND gates are coupled in parallel with the first AND gates by resistors coupled between corresponding outputs of the N number of AND gates and the input test node, where N is a natural counting number equal to at least 1.

16. The RF receiver front-end of claim 15 wherein the AND gates each further comprise a tri-state terminal coupled to the controller through a tri-state control line, wherein the controller is configured to tri-state the AND gates when the built-in self-test is not being conducted.

17. A method for performing a built-in self-test of an RF receiver front-end, the method comprising:
providing an input test signal using an oscillator and a buffer within a RF calibration generator;
coupling the input test signal to an RF input terminal of a low-noise amplifier (LNA), wherein the LNA is disposed within an RF integrated circuit chip and has an RF output terminal;
digitizing an output test signal at an output test node associated with the RF output terminal using an analog-to-digital converter (ADC); and
analyzing the digitized output test signal with a controller to determine one or more characteristics of the RF receiver front-end.

18. The method of claim 17 further comprising supplying a stable supply voltage between 800 mV and 810 mV to the buffer using a low-dropout voltage regulator.

19. The method of claim 17 wherein the one or more characteristics of the RF receiver front-end include at least one of:
a value of LNA source impedance;
a value of LNA gain;
an in-phase/quadrature imbalance;
a frequency characteristic; and
received signal distortion.

20. The method of claim 17, wherein the oscillator is a ring-type oscillator configured to generate a square-wave test signal.

21. The method of claim 17 further comprising:
closing an electronically controllable switch between the antenna port terminal and the LNA during the built-in self-test to couple the input test signal to the RF input terminal; and
opening the electronically controllable switch during normal operation of the RF receiver front-end, wherein normal operation is receiving external RF signals.

22. The method of claim 17 further comprising processing the output test signal with analog processing circuitry coupled between the output test node and the ADC prior to analyzing the output test signal for determining the one or more characteristics of the RF receiver front-end.

23. A wireless communication device comprising:
receive circuitry having an RF receiver front-end configured to receive radio frequency (RF) signals;
a baseband processor configured to process a digitized version of the RF signals received by the receive circuitry and to extract the information or data bits conveyed in the received RF signals;
transmit circuitry configured to receive encoded data from the baseband processor and to modulate a carrier signal with the encoded data; and
wherein the RF receiver front-end comprises:
an RF integrated circuit chip having an antenna port terminal for coupling to an external antenna;
a low-noise amplifier (LNA) coupled between an RF input terminal and an RF output terminal, wherein the LNA is disposed within the RF integrated circuit chip and the RF input terminal is coupled to the antenna port terminal; and
an RF calibration generator integrated onto the RF integrated circuit chip, configured to provide a built-in self-test for the RF receiver front-end, wherein the RF calibration generator comprises:
a first resistor coupled in series between the RF input terminal and a fixed voltage node through an input test node;
an electronically controllable test switch coupled in series with the first resistor between the RF input terminal and the fixed voltage node;
an oscillator configured to generate a square-wave signal for an input test signal;
a buffer having an input coupled to an output of the oscillator, wherein the buffer is configured to generate the input test signal by sharpening edges of the square-wave signal with a rail-to-rail amplitude; and
a second resistor coupled between an output of the buffer and the test node.

24. The wireless communication device of claim 23 further comprising a low-dropout voltage regulator configured to supply a stable supply voltage to the buffer.

25. The wireless communication device of claim 24 wherein the supply voltage supplied to the buffer by the low-dropout voltage regulator is between 800 mV and 810 mV.

26. The wireless communication device of claim 23 wherein the oscillator is a ring-type oscillator.

27. The wireless communication device of claim 23 further comprising a controller configured to perform a built-in self-test to determine one or more characteristics of the RF receiver front-end.

28. The wireless communication device of claim 27 further comprising an electronically controllable antenna switch coupled in series between the antenna port terminal and the RF input terminal, wherein the controller is configured to close the electronically controllable antenna switch during reception of RF signals through the antenna port terminal and open the electronically controllable antenna switch during the built-in self-test.

29. The wireless communication device of claim 27 further comprising an analog-to-digital converter having an analog input coupled to the output test node and a digital output, wherein the controller is configured to close the electronically controllable test switch to perform the built-in self-test, receive a digitized version of an output test signal at the output test node, and open the electronically controllable test switch during reception of RF signals through the antenna port.

30. The wireless communication device of claim 27 further comprising analog processing circuitry coupled between the analog input of the analog-to-digital converter and the output test node.

31. The wireless communication device of claim 27 wherein the one or more characteristics of the RF receiver front-end are a value of LNA source impedance derived the output test signal at the output test node.

32. The wireless communication device of claim 27 wherein the one or more characteristics of the RF receiver front-end are a value of LNA gain derived from the output test signal at the output test node.

33. The wireless communication device of claim 27 wherein the one or more characteristics of the RF receiver front-end are a value of in-phase/quadrature imbalance derived from the output test signal at the output test node.

34. The wireless communication device of claim 27 wherein the one or more characteristics of the RF receiver front-end are a frequency characteristic derived from the output test signal at the output test node.

35. The wireless communication device of claim 27 wherein the one or more characteristics of the RF receiver front-end are received signal distortion derived from the output test signal at the output test node.

36. The wireless communication device of claim 27 wherein the buffer is a first AND gate having an oscillator input coupled to the oscillator and an enable input coupled to a control bus of the controller.

37. The wireless communication device of the claim 27 further comprising an N number of additional AND gates that each have an oscillator input coupled to the oscillator and an enable input coupled to the control bus of the controller, wherein the N number of additional AND gates are coupled in parallel with the first AND gate by resistors coupled between corresponding outputs of the N number of AND gates and the test node, where N is a natural counting number equal to at least 1.

38. The wireless communication device of claim 37 wherein the AND gates each further comprise a tri-state terminal coupled to the controller through a tri-state control line, wherein the controller is configured to tri-state the AND gates when the built-in self-test is not being conducted.
